(19) United States
(12) Patent Application Publication
(10) Pub. No.: US 2023/0341323 A1
(43) Pub. Date: Oct. 26, 2023

(54) CONTINUOUS INFRARED SPECTROSCOPY SYSTEM AND METHOD

(71) Applicant: DXCOVER LIMITED, Glasgow (GB)

(72) Inventors: Matthew J. Baker, Glasgow (GB); Mark Hegarty, Glasgow (GB); Holly Jean Butler, Glasgow (GB)

(21) Appl. No.: 18/027,834

(22) PCT Filed: Oct. 15, 2021
(86) PCT No.: PCT/GB2021/052673

§ 371 Date: Mar. 22, 2023

(30) Foreign Application Priority Data
Oct. 16, 2020 (GB) 2016426.5

(51) Int. Cl. G01N 21/3577; G01N 21/552; G01N 35/00

(52) U.S. Cl. CPC G01N 21/3577; G01N 21/552; G01N 35/00029; G01N 35/00009; G01N 2021/3595

(57) ABSTRACT

A sample support apparatus (150) for use in a spectrometer (285), comprises an elongate support (110) comprising a plurality of receiving portions (112) each configured to receive a respective internal reflection element (IRE) or IRE slide (135), the elongate support having a sample side and a beam side opposite the sample side; and a plurality of IREs or IRE slides (135), each IRE or IRE slide provided at a respective receiving portion (112) of the elongate support (110), wherein each IRE or IRE slide (135) has at least one sample-receiving portion provided on a sample side thereof, and at least one beam-receiving portion provided on a beam side thereof. The sample support apparatus (150) has a stowed configuration, and a deployed configuration configured to allow application of a sample (276) on one or more of the plurality of IREs or IRE slides (135).

### FIELD

The present invention relates to apparatuses and methods for performing Infrared spectroscopy analysis, and in particular, though not exclusively, for performing ATR-FTIR spectroscopy analysis.

### BACKGROUND

Fourier Transform Infrared (FTIR) spectroscopy is a technique commonly used in chemical sciences in order to identify discrete vibrations of chemical bonds. This technique uses light in the mid-infrared (MIR) region (4000-400 cm⁻¹) that is, in the same frequency range as the frequency range of chemical bond vibrations.

Biological molecules are known to actively vibrate in this range of wavelengths, and thus FTIR spectroscopy lends itself to biological applications. When a biological sample is irradiated with MIR light, some of this energy is absorbed by the sample. The absorption profile of a given sample is representative of the chemical bonds present within a sample, and can be used to characterise complex biological materials.

An example of a particular type of analysis using FTIR spectroscopy is in the investigation of proliferative disorders, such as cancer, which are caused by uncontrolled and unregulated cellular proliferation and can, in some cases, lead to the formation of a tumour.

There are three principal sampling modes used in FTIR spectroscopy: transmission, transflection, and attenuated total reflection (ATR).

Attenuated Total Reflection (ATR) employs an internal reflective element (IRE) through which the IR beam is passed. The sample is deposited directly onto the IRE, and maintained in close contact with it. These IREs can be made from a number of different materials, including diamond, germanium, zinc selenide or silicon. Each material differs slightly in its refractive properties. When IR light is passed through an IRE above a defined angle, described as the critical angle, the light is internally reflected through this medium. When the beam meets the IRE and sample interface, this results in the production of an evanescent wave which penetrates into the sample. The depth of this penetration is dependent upon the wavelength of light, the refractive indices of the IRE and the sample, as well as the angle of incidence: however, is generally in the region between 0.5-2 μm. The beam is then reflected by the IRE towards a detector.

One benefit of ATR-FTIR is the reduced influence of water absorbance on the IR spectrum, allowing the interrogation of water-containing samples. This is particularly important to biological samples which will intrinsically contain water. Although water molecules still absorb in this sampling mode, the penetration depth of the evanescent wave is much smaller than the pathlength of transmission and transflection FTIR spectroscopy. Therefore, much less water is being sampled, allowing the underlying sample absorbance to still be monitored.

This technique has therefore lent itself well to the analysis of biological samples, particularly biofluids. These are known to be information rich and have been shown to be suitable for the detection of disease in a patient population. It has been shown that this technique is capable of diagnosing brain tumours at a range of severities using blood serum from a cohort of 433 patients (Hands et al., 2016; Hands et al. 2014).

A method of diagnosing brain cancer by performing Attenuated Total Reflection—Fourier Transform Infrared (ATR-FTIR) spectroscopic analysis of blood samples has been described in WO 2014/076480). In contrast to conventional ATR-IR (where a sample is placed on a substrate that is then brought into contact with the ATR crystal), the ATR crystal was used as the substrate for the sample. This method provides a point of care and non-destructive diagnostic test, but requires thorough cleaning and drying of the ATR crystal before it can be reused for analysis of another sample.

Thus, despite the suitability of ATR-FTIR for analysis of biological samples, a significant instrumentation limitation is that an ATR-FTIR spectrometer, or an ATR attachment for an FTIR spectrometer, is typically composed of a single IRE. As the sample is placed directly onto this IRE, this limits this technique to a single sample approach where the sample needs to be prepared, analysed, removed from the IRE, followed by a thorough clean of the IRE, before the next sample can be analysed using the instrument. In the case of biofluids like blood serum, this process is significantly elongated as there is a requirement to dry the sample, to unearth subtle biomolecular information. The time this takes is volume dependent, but has been determined as 8 minutes for 1 μL blood serum spot. As a consequence, this approach cannot be considered high-throughput. Reasons for this restriction include the high cost of current IREs, combined with engineering requirements for specific attachments.

U.S. Pat. No. 7,255,835 (Franzen et al) discloses an apparatus and method for acquiring an infrared spectrum of a solubilised sample, in a FTIR microscope.

WO 2018/178669 (Baker et al) discloses a sample slide for use in a spectrometer, wherein the sample slide comprises a plurality of sample-receiving portions provided on a sample side of the slide, and a plurality of beam-receiving portions provided on a beam-receiving side of the slide, each beam-receiving portion being arranged opposite a respective sample-receiving portion. Each beam-receiving portion is configured to act as an internal reflection element (IRE), and as such the sample slide allows for the analysis of multiple samples on a single slide, particularly when used in conjunction with an indexing system disclosed therein, thus improving efficiency of sample processing compared to conventional techniques. The slides, which can be made from silicon, are disposable, thus reducing the risk of contamination and increasing the level of safety when dealing with hazardous materials or biological samples. Whilst this enables more efficient analysis and makes the technology ready for initial clinical use, this approach is intended to be used with classic benchtop spectrometers, and remains somewhat limited in terms of volume analysis/throughput in certain applications.

As such, there is a need for an ATR-FTIR analysis system with further improved throughput capability.

### SUMMARY

According to a first aspect, there is provided a sample support apparatus for use in a spectrometer, wherein the sample support apparatus comprises:

an elongate support comprising a plurality of receiving portions each configured to receive a respective internal reflection element (IRE) or IRE slide, the elongate support having a sample side and a beam side opposite the sample side; and

a plurality of IREs or IRE slides, each IRE or IRE slide provided at a respective receiving portion of the elongate support, wherein each IRE or IRE slide has at least one sample-receiving portion provided on a sample side thereof, and at least one beam-receiving portion provided on a beam side thereof, and

wherein the sample support apparatus has a stowed configuration, and a deployed configuration configured to allow application of a sample on one or more of the plurality of IRE or IRE slides.

The sample side of the IREs or IRE slides may face opposite the elongate support.

The beam side of the IREs or IRE slides may face towards the elongate support.

The sample support apparatus may be configured to be stowed, e.g. during storage, transport, or the like. By such provision, the sample support apparatus may provide a convenient support medium for spectrometry, e.g. ATR-FTIR spectrometry, with potential for high throughput measurement and/or analysis.

The sample support apparatus, e.g. elongate support thereof, may be flexible.

The sample support apparatus, e.g. elongate support thereof, may be capable of being wound or spooled on or around a storing device, e.g. a reel, spool or the like. Thus, the term “flexible” will be herein understood as not merely having the ability to bend of flex, but as being “reelable” or “spoolable”. The sample support apparatus may be provided in a wound or reeled form in its stowed configuration.

Thus, in an embodiment, there is provided a sample support apparatus for use in a spectrometer, wherein the sample support apparatus comprises:

an elongate flexible support comprising a plurality of receiving portions each configured to receive a respective internal reflection element (IRE) or IRE slide, the elongate flexible support having a sample side and a beam side opposite the sample side; and

a plurality of IRE or IRE slides, each IRE or IRE slide provided at a respective receiving portion of the elongate flexible support, wherein each IRE or IRE slide has at least one sample-receiving portion provided on a sample side thereof, and at least one beam-receiving portion provided on a beam side thereof.

The elongate flexible support may comprise or may be provided in the form of a ribbon, tape or the like.

The sample support apparatus, e.g. elongate support thereof, may be foldable. For example, adjacent portions of the elongate support, e.g. adjacent containing one or more receiving portions, may be provided with a foldable connection which may include a hinge, a pin, or the like. The sample support apparatus may be provided in a concertina-like structure in its stowed configuration.

The plurality of receiving portions may be aligned longitudinally along the elongate support.

Advantageously, the plurality of receiving portions may be spaced apart at regular intervals. By such provision, automation associated with the manufacture of the apparatus, e.g. the application of the IREs or IRE slides, and/or with the analysis of samples, e.g. the application of a sample on the IREs or IRE slides, may be simplified.

The plurality of IREs or IRE slides may be spaced apart at regular intervals on the apparatus, e.g. on the elongate support.

The present arrangement may allow analysis of samples by infrared spectroscopy, e.g., ATR-FTIR spectroscopy, in an in-line and/or continuous process with the potential for improved throughput.

Each IRE or IRE slide may have one sample-receiving portion provided on a sample side thereof, and one beam-receiving portion provided on a beam side thereof. In such instance, each receiving portion of the elongate support is configured to receive an IRE or IRE slide with one sample-receiving portion and one beam-receiving portion. Advantageously, as the IREs or IRE slides are typically made of a rigid material, this arrangement may keep each IRE or IRE slide relatively small, thus improving the flexibility and reelability of the sample support apparatus.

Thus, in an embodiment of the first aspect, there is provided a sample support apparatus for use in a spectrometer, wherein the sample support apparatus comprises:

an elongate support comprising a plurality of receiving portions each configured to receive a respective internal reflection element (IRE), the elongate support having a sample side and a beam side opposite the sample side; and

a plurality of IREs, each IRE provided at a respective receiving portion of the elongate support, wherein each IRE has a sample-receiving portion provided on a sample side thereof, and a beam-receiving portion provided on a beam side thereof, and

wherein the sample support apparatus has a stowed configuration, and a deployed configuration configured to allow application of a sample on one or more of the plurality of IREs.

Each IRE slide may have more than one sample-receiving portions provided on a sample side of the slide, and more than one beam-receiving portions provided on a beam side of the slide. In such instance, each receiving portion of the elongate support is configured to receive an IRE slide having more than one sample-receiving portions and more than one beam-receiving portions. For example, the slides may be substantially as described in WO 2018/178669 (Baker et an, the content of which is incorporated herein by reference in its entirety.

The receiving portions may each comprise one or more openings on a beam side of the elongate support. By such provision, irradiation of a receiving portion using a radiation source, e.g. infrared (IR), from a beam side of the elongate support, may allow irradiation of a beam-receiving portion of an associated IRE.

For example, when each IRE has one sample-receiving portion provided on a sample side of the slide, and one beam-receiving portion provided on a beam side of the slide, each receiving portion may comprise one opening on a beam side of the elongate support.

When each IRE slide has more than one sample-receiving portions provided on a sample side of the slide, and more than one beam-receiving portions provided on a beam side of the slide, each receiving portion may comprise more than one, e.g. a corresponding number of, openings on a beam side of the elongate support, each opening configured to be associated with a respective beam-receiving portion of the IRE slide.

The openings may have a size, e.g. width, depth or diameter, less than the size, e.g. width, depth or diameter, of the IREs. This may help prevent an IRE falling through a respective receiving portion, by ensuring that at least a portion, e.g. an outer portion, of an IRE is supported by its respective receiving portion. Typically, the openings may have a size, e.g. width, length or diameter, of approximately 1-10 mm. e.g. 2-5 mm.

The receiving portions may each comprise a recess on a sample side of the elongate support. By such provision, an IRE may be located within a recess of a respective receiving portion of the elongate support. The provision of a recess may ensure that an IRE may be securely and reliably provided and/or located at its respective receiving portion on the elongate support.

The recesses may have a size, e.g. width, length or diameter, similar to the size, e.g. width, length or diameter, of a respective IRE or IRE slide. The recesses may have a size, e.g. width, length or diameter, marginally greater than the size, e.g. width, length or diameter, of a respective IRE or IRE slide.

For example, when each IRE has one sample-receiving portion provided on a sample side of the slide, and one beam-receiving portion provided on a beam side of the slide, the recesses may each have a size, e.g. width, length or diameter, of approximately 5-20 mm. e.g. 5-10 mm. For example, for an IRE having a dimension of about 6 mm×6 mm, an associated recess may have a dimension of about 6.3 mm×6.3 mm.

When each IRE slide has four sample-receiving portions provided on a sample side of the slide, and four beam-receiving portions provided on a beam side of the slide, the recesses may each have a size of approximately 40 mm×10 mm to 80 mm×20 mm, e.g. about 75 mm×25 mm.

The elongate support may comprise at least 5, e.g. at least 10, e.g. at least 20, typically at least 100, receiving portions. For example, the elongate support may comprise up to 1000, e.g. up to 5000 receiving portions. The elongate support may comprise between 5 and 5000 IRE receiving portions, e.g. between 10 and 5000 receiving portions, e.g. between 100 and 5000 receiving portions.

The sample support apparatus may comprise at least 5, e.g. at least 10, e.g. at least 20, typically at least 100, IRES. For example, the sample support apparatus may comprise up to 1000, e.g. up to 5000 IREs. The sample support apparatus may comprise between 5 and 5000 IREs, e.g. between 10 and 5000 IREs, e.g. between 100 and 5000 IREs.

Advantageously, the apparatus, e.g. elongate support thereof, may have a width corresponding to the standard width of a microscope slide. This may help allow the apparatus to be used with a conventional FTIR spectrometer. Typically, the elongate support may have a width of approximately 10-30 mm, e.g. approximately 10-20 mm, typically approximately 12-16 mm.

Advantageously, the apparatus, e.g. elongate support thereof, may have a height or depth corresponding to the standard height or depth of a microscope slide. This may help allow the apparatus to be used with a conventional FTIR spectrometer. Typically, the elongate support may have a height of approximately 0.5-2 mm, typically approximately 1 mm.

The elongate support, e.g. elongate flexible support, may be made of a synthetic or a natural polymeric material, for example a thermoplastic material such as High Impact Polystyrene (HIPS). Other suitable flexible materials may be used as will be appreciated by a person of skill in the art.

The sample support apparatus may further comprise a holding element provided on a sample side of the elongate support and configured to cover at least a portion of at least one IRE or IRE slide, typically of at least one IRE.

The holding element may be configured to cover at least a portion of a sample side of at least one IRE.

The holding element may be configured to secure and/or hold at least one IRE slide in place, e.g. within its respective receiving portion and/or respective recess.

There may be provide a plurality of holding elements.

For example, each holding element may be configured to cover a portion of a sample side of a respective IRE. In such instance, each IRE may be associated with a respective holding element. There may be provided a holding element on a sample side of each IRE. The/each holding element may comprise at least one aperture configured to expose a portion of the sample side of a respective IRE.

Alternatively, or additionally, a holding element may be configured to cover a portion of a sample side of more than one IRE. In such instance, the/each holding element may comprise a plurality of apertures. Each aperture may be configured to expose a portion of the sample side of a respective IRE. For example, a holding element may be configured or sized so as to cover a portion of a sample side of 2, 3, 4, 5 or more IREs.

Alternatively, or additionally, there may be provided a single holding element configured to cover a portion of a sample side of the IREs. The holding element may have a plurality of apertures, each aperture configured to expose a portion of the sample side of a respective IRE. In such instance, there may be provided a single, continuous holding element provided on a sample side of the support.

The holding element or plurality of holding elements may define a plurality of apertures, each aperture corresponding to or exposing a respective sample-receiving portion of an IRE.

The/each aperture may be of a size similar to, e.g. equal to or less than, the size of a sample-receiving portion of an IRE. The provision of an aperture may allow the application of a sample on the sample side of an IRE, whilst providing a further physical barrier between adjacent sample-receiving portions, thus further reducing the risk of cross-contamination between adjacent sample-receiving portions or IREs.

One or more apertures, e.g. each aperture, may have a size, e.g. width, length or diameter, of approximately 1-10 mm. One or more apertures, e.g. each aperture, may have a size of approximately 1-10 mm×1-10 mm. Typically, one or more aperture, e.g. each aperture, may have a size of approximately 3-5 mm×3-5 mm. In an embodiment, one or more apertures may have a size of approximately 3.8 mm in diameter and/or approximately 3.8 mm×3.8 mm.

The holding element(s) may be provided in the form of a film or tape. The holding element(s) may comprise or may be provided with an adhesive on a beam side thereof, which may allow the holding element(s) to be attached or affixed to the elongate support.

Typically, the holding element(s) may cover at least a portion of a sample side of the elongate support, e.g. directly adjacent or around the IREs. The holding element(s) may cover an outer portion of a sample side of the IREs or an outer portion of a sample-receiving portion of an IRE. By such provision, at least a portion of the IREs or IRE slides or of the sample-receiving portion thereof, e.g. an outer portion thereof, is sandwiched between the flexible support and the holding element(s).

The holding element may be made from a pulp-based material such as paper, a polymeric material such as polyethylene, polypropylene, polycarbonate or the like, or a composite or multilayer material such as a polymer-coated paper pulp-based material, e.g. a polyethylene-coated adhesive paper.

The structure of the IREs, and in particular of the sample-receiving portion(s) and/or of the beam-receiving portion(s) thereof, may be generally as described in WO 2018/178669 (Baker et al), the content of which is incorporated herein by reference.

The beam-receiving portions of at least one, e.g. each IRE, may be configured to permit a radiation beam to penetrate a surface of the beam-receiving portions on the beam side of the at least one, e.g. each, IRE. Advantageously, the beam-receiving portions may be configured to permit a radiation beam to penetrate a surface of a beam-receiving portion on the beam side of the IRE at angle such that the radiation beam may be reflected on an internal surface of a respective sample-receiving portion, and may be permitted to exit the IRE through the surface of the beam-receiving portion on the beam side.

The/each beam-receiving portion may comprise or may define a plurality of grooves and/or prisms, preferably a plurality of elongate grooves and/or prisms, e.g., a plurality of aligned, parallel and/or adjacent grooves and/or prisms.

Each groove may have or may define a first groove face and a second groove face. The/each first groove face may be arranged to allow a radiation beam to penetrate, e.g. inwards, a surface thereof. The/each second groove face may be arranged to allow a radiation beam to penetrate, e.g. outwards, a surface thereof.

Each prism may have or may define a first prism face and a second prism face. The/each first prism face may be arranged to allow a radiation beam to penetrate, e.g. inwards, a surface thereof. The/each second prism face may be arranged to allow a radiation beam to penetrate, e.g. outwards, a surface thereof.

Typically, the first groove face of a groove may correspond to the first prism face of an adjacent prism. The second groove face of a groove may correspond to the second prism face of an adjacent prism.

In an embodiment, the prisms may protrude outwardly, e.g. relative to a surface, e.g. a flat surface, of the slide on the beam side thereof. In another embodiment, the prisms may be recessed, e.g. relative to a surface, e.g. a flat surface, of the slide on the beam side thereof. Alternatively, an outer portion of the prisms may protrude outwardly, e.g. relative to a surface, e.g. a flat surface, of the slide on the beam side thereof, and an inner portion of the prisms may be recessed, e.g. relative to a surface, e.g. a flat surface, of the slide on the beam side thereof.

The IRE(s) may have a thickness, e.g. between a sample side and a beam side, in the range of 100-1000 μm, e.g. in the range of 200-800 μm, e.g. in the range of 300-700 μm. In some embodiments, the IRE(s) may have a thickness, e.g. between a sample side and a beam side, of approximately 380 μm, 525 μm or 675 μm.

The/each groove or prism may have a width, e.g. a maximum width, in the range of 50-500 μm, e.g. in the range of 50-300 μm, e.g. in the range of 100-250 μm. In some embodiments, the/each groove or prism may have a width, e.g. a maximum width, of approximately 100 μm, 150 μm, 200 μm or 250 μm.

The/each groove or prism may have a depth, e.g. a maximum depth, in the range of 50-500 μm, e.g. in the range of 50-300 μm, e.g. in the range of 70-200 μm. In some embodiments, the/each groove or prism may have a depth, e.g. a maximum depth, of approximately 70 μm, 100 μm, 140 μm or 175 μm.

Adjacent grooves may have a spacing in the range of 0-200 μm, e.g. in the range of 10-150 μm, e.g. in the range of 25-100 μm. In some embodiments, adjacent grooves may have a spacing of approximately 25, 50 or 100 μm. When a spacing between adjacent grooves is present, an outermost region of a respective prism comprise a levelled and/or flat portion, e.g. at a tip or outermost region thereof.

A surface, e.g. a first face and/or a second face or the/each groove or prism, may extend at an angle, e.g. relative to a surface of the IRE, e.g. on a beam side thereof, in the region of 30-75°, e.g. 35-55°. It will be appreciated that the exact angle chosen for a given IRE may depend on the material selected for manufacture of the IRE, and/or on the expected angle of incidence of the irradiation beam. For example, the angle a groove face and/or prism face may depend on the specific material used and/or on the crystalline structure thereof. When the IRE is made of a<100>silicon material, a first face and/or a second face or the/each groove or prism, may extend at an angle, e.g. relative to a surface of the IRE, e.g. on a beam side thereof, in the region of 40-75°, e.g. 45-65°, .e.g. approximately 55°, e.g. 54.74°. When the IRE is made of a<110>silicon material, a first face and/or a second face or the/each groove or prism, may extend at an angle, e.g. relative to a surface of the IRE, e.g. on a beam side thereof, in the region of 30-50°, e.g. 30-40°, .e.g. approximately 35°, e.g. 35.3°.

The IREs may be made of germanium, diamond, zinc selenide, or silicon. Advantageously, the IREs may be made of silicon. The use of silicon may considerably reduce the costs associated with the manufacture of the IREs, and may allow the apparatus to be used as a disposable apparatus, thus avoiding the need for cleaning and drying the apparatus before and/or after use.

According to a second aspect there is provided a kit of parts for providing a sample support apparatus according to the first aspect, the kit of parts comprising:

an elongate support comprising a plurality of receiving portions each configured to receive a respective internal reflection element (IRE) or IRE slide, the elongate support having a sample side and a beam side opposite the sample side, wherein the elongate support has a stowed configuration, and a deployed configuration configured to allow application of one or more IREs or IRE slides thereon; and

a plurality of IREs or IRE slides, each IRE or IRE slide configured to be provided at a respective receiving portion of the elongate support, wherein each IRE or IRE slide has at least one sample-receiving portion provided on a sample side thereof, and at least one beam-receiving portion provided on a beam side thereof.

The kit of parts may further comprise a holding element arranged to be provided on a sample side of the elongate support and configured to cover at least a portion of at least one IRE or IRE slide.

The features described in respect of the apparatus of the first aspect are equally applicable to the kit of parts according to the second aspect, and are therefore not repeated here for brevity.

According to a third aspect, there is provided a method of making a sample support apparatus, the method comprising:

providing an elongate support comprising a plurality of receiving portions each configured to receive a respective internal reflection element (IRE) or IRE slide, the elongate support having a sample side and a beam side opposite the sample side, wherein the sample support apparatus has a stowed configuration, and a deployed configuration configured to allow application of a sample on one or more of the plurality of IRE or IRE slides; and

disposing at least one IRE or IRE slide in a respective receiving portion of the elongate support, wherein the at least one IRE or IRE slide has at least one sample-receiving portion provided on a sample side thereof, and at least one beam-receiving portion provided on a beam side thereof.

The method may comprise disposing a plurality of IRE or IRE slides on the elongate support, each IRE or IRE slide being provided in a respective receiving portion of the elongate support.

The method may comprise moving, e.g. pulling, unwinding, the elongate support, e.g. in a linear direction.

The method may comprise automatically placing the IREs or IRE slides in their respective receiving portions of the elongate support.

The method may comprise feeding the elongate support through a slide dispenser configured to place an IRE or IRE slide in a respective receiving portion of the elongate support. The method may comprise sequentially:
(a) moving the elongate support through the slide dispenser by a distance equal to a receiving portion of the elongate support; and
(b) providing an IRE or IRE slide in a respective receiving portion of the elongate support.

The method may comprise repeating steps (a) and (b).

The method may further comprise applying a holding element on a sample side of the elongate support so as to cover at least a portion of at least one IRE or IRE slide.

The method may comprise feeding the elongate support through a cover dispenser configured to apply a holding element on a sample side of the elongate support so as to cover at least a portion of at least one IRE or IRE slide.

The method may comprise:
(a) moving the elongate support through the slide dispenser by a distance equal to a receiving portion of the elongate support;
(b) providing an IRE or IRE slide in a respective receiving portion of the elongate support; and
(c) applying a holding element on a sample side of the elongate support so as to cover at least a portion of at least one IRE or IRE slide.

Typically, steps (b) and (c) may be performed simultaneously. Conveniently, the IRE or IRE slide of step (b) and the at least one IRE or IRE slide of step (c) may be different.

Typically, the cover dispenser may be provided downstream relative to the slide dispenser.

The method may comprise repeating steps (a), (b) and (c).

The method may comprise stowing the sample support apparatus.

The method may comprise winding the sample support apparatus, e.g. on a reel, spool or the like. The elongate support of the sample support apparatus may be flexible.

The method may comprise folding the sample support apparatus.

Thus, in an embodiment, the method may comprise:
(a) moving the elongate support through the slide dispenser by a distance equal to a receiving portion of the elongate support;
(b) providing an IRE or IRE slide in a respective receiving portion of the elongate support;
(c) apply a holding element on a sample side of the elongate support so as to cover at least a portion of at least one IRE or IRE slide; and
(d) stowing the sample support apparatus.

The features described in respect of the apparatus of the first aspect are equally applicable to the method according to the third aspect, and are therefore not repeated here merely for brevity.

According to a fourth aspect there is provided a system for measuring a sample, the system comprising:

a dispenser configured to supply a sample support apparatus according to the first aspect;

a sample dispenser configured to apply a sample on a sample-receiving portion of the sample support apparatus; and

a spectrometer.

The dispenser may comprise or may be a reel, spool or the like.

The spectrometer may be an IR spectrometer, e.g. a FTIR spectrometer, typically an ATR-FTIR spectrometer, e.g. an FTIR spectrometer equipped with or coupled to an ATR element.

The system may be configured to dispense the sample support apparatus from the dispenser, e.g. in a linear direction.

The sample dispenser may be provided downstream form the dispenser.

The spectrometer may be provided downstream from the sample dispenser.

The system may be automated.

The system may further comprise a dryer configured to dry a sample on the sample support apparatus. The dryer may comprise or may be an oven.

The dryer may be configured to provide heat and/or ventilation.

The dryer may be configured to eat the sample(s) and/or sample support apparatus at a temperature of approximately 28-36° C., e.g., about 30-36° C., e.g. about 32-35° C., e.g. about 35° C.

The dryer may be configured to circulate a gas therein. The dryer may be configured to circulate a gas at a flow rate in the range of about 5-200 m³/h, e.g. about 10-125 m³/h, e.g., about 15-115 m³/h. The flow rate may be at least 10 m³/h, e.g. at least m³/h, e.g. at least 50 m³/h, e.g. at least 90 m³/h.

The spectrometer may be provided downstream from the dryer.

The system may be configured to perform in-line or continuous analysis of one or more samples provided on the sample support apparatus.

The system may comprise or may be associated with a controller configured to control movement, e.g. translation, of the sample support apparatus.

The system may comprise a plurality of spectrometers. For example, the system may comprise a plurality of spectrometers, each spectrometer configured to measure a respective sample on the sample support apparatus. By such provision, the time required to perform measurement or analysis of the samples on the sample support apparatus may be reduced.

According to a fifth aspect, there is provided a method for measuring a sample, the method comprising:

supplying a sample support apparatus according to a first aspect;

applying a sample on a sample-receiving portion of the sample support apparatus; and

moving the sample support apparatus to a spectrometer so as to measure the sample.

The method may further comprise drying the sample.

The method may comprise drying the sample before the measurement step.

The method may comprise translating the sample support apparatus, e.g. in a linear direction.

At least one sample, e.g. the samples, may comprise a biological sample, e.g. a biofluid such as blood or blood serum. Typically, when providing the sample(s) on the IREs, the sample(s) may be in liquid form.

The method may comprise drying the samples and/or sample support apparatus at a temperature of approximately 28-36° C., e.g., about 30-36° C., e.g. about 32-35° C., e.g. about 35° C.

The method may comprise drying the samples and/or sample support apparatus under controlled gas flow conditions. The flow rate may be in the range of about 5-200 m³/h, e.g. about 10-125 m³/h, e.g., about 15-115 m³/h. The flow rate may be at least 10 m³/h, e.g. at least 15 m³/h, e.g. at least 50 m³/h, e.g. at least 90 m³/h.

The method may comprise flowing a gas, e.g. air, over the sample(s), for example for a predetermined length of time.

The method may comprise drying the samples and/or sample support apparatus slide such that the drying time of the samples and/or sample slide is approximately 30 sec to 5 minutes, e.g. 1-3 minutes, e.g. approximately 2 minutes.

Advantageously, the method may be automated.

The method may comprise moving, e.g. translating and/or unwinding the sample support apparatus, by a predetermined distance.

The method may comprise ceasing movement of the sample support apparatus.

The method may comprise applying a sample on a sample-receiving portion of the sample support apparatus whilst the sample support apparatus is stationary. This may help the accuracy of the sample application.

The method may comprise applying one sample on a respective sample-receiving portion during a corresponding stationary phase.

Alternatively, the method may comprise a plurality of samples each on a respective sample-receiving portion during a stationary phase.

Once the sample or plurality of samples have been dispensed on a section of the sample support apparatus, the method may comprise moving, e.g. unwinding or translating, the sample support apparatus, by a distance sufficient to locate an adjacent section of the sample support apparatus near the sample dispenser.

The method may comprise analysing one or more samples whilst the sample support apparatus is stationary. This may help the accuracy of the measurement.

Typically, the method may comprise measuring one or more samples located downstream from the sample dispenser. By such provision, the time elapsed to move, e.g. translate, the sample(s) between the sample dispenser and the spectrometer(s) may allow the sample(s) to dry before measurement.

It will be appreciated that the distance between the sample dispenser and the spectrometer(s), the speed of translation, and/or the time of the stationary phase, may depend on a number of factors, including for example the time required for spectrometry analysis, and the time required for optimum sample drying.

Thus, the method may comprise:

(a) supplying a sample support apparatus according to a first aspect;

(b) moving the sample support apparatus by a predetermined distance;

(c) ceasing movement of the sample support apparatus, wherein during step (c), the method comprises:
(i) applying one or more samples on one or more respective sample-receiving portions of a first section of the sample support apparatus; and
(ii) measuring, using a spectrometer, one or more samples located in a second section of the sample support apparatus located downstream from the first section.

The method may comprise repeating steps (b) and (c).

When the sample is a wet sample, the method may comprise:

(a) supplying a sample support apparatus according to a first aspect;

(b) moving the sample support apparatus by a predetermined distance;

(c) ceasing movement of the sample support apparatus;

wherein during step (c), the method comprises:
(i) applying one or more samples on one or more respective sample-receiving portions of a first section of the sample support apparatus;
(ii) drying one or more samples located in a second section of the sample support apparatus located downstream from the first section; and
(iii) measuring, using a spectrometer, one or more samples located in a third section of the sample support apparatus located downstream from the second section.
The method may comprise repeating steps (b) and (c).

For the avoidance of doubt, any feature described in respect of any aspect of the invention may be applied to any other aspect of the invention, in any appropriate combination. For example, method features may be applied to apparatus features and vice versa.

### BRIEF DESCRIPTION OF THE DRAWINGS

Various aspects of the invention will now be described by way of example only, and with reference to the accompanying drawings, in which:

FIG. 1 is a schematic representation of the principles of ATR-IR spectroscopy;

FIG. 2 is a schematic representation of a conventional set-up showing a single IRE for performing ATR-IR spectroscopy analysis;

FIG. 3 is a schematic view of a system for making a sample support apparatus according to an embodiment;

FIG. 4 is a schematic view of a sample support apparatus according to an embodiment;

FIG. 5 is a view of an alternative embodiment of a sample support apparatus;

FIGS. 6, 7 and 8 show a bottom view and cross-sectional views of an embodiment of an IRE slide for use in the sample support apparatus of FIG. 4 or FIG. 5;

FIG. 9 is a schematic view of a system for measuring a sample according to an embodiment.

### DETAILED DESCRIPTION

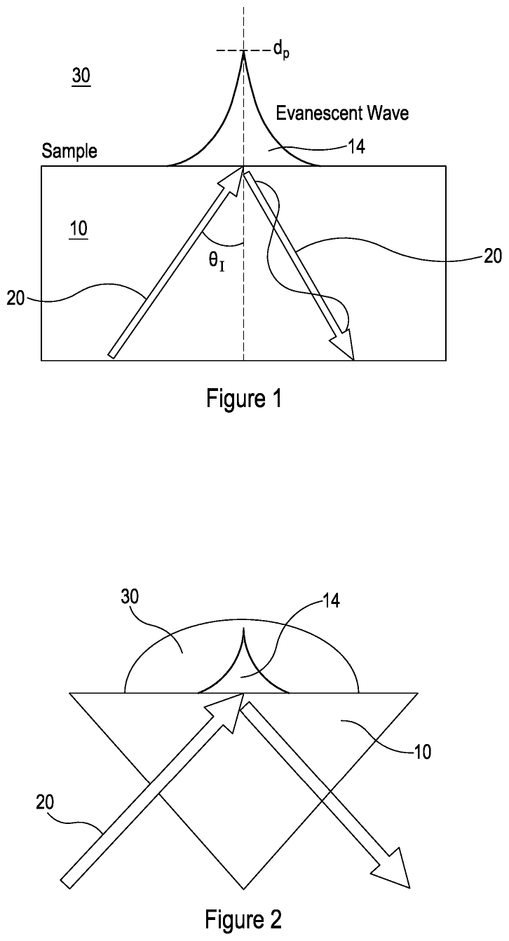

Referring to FIG. 1 there is shown a schematic representation of the principles of ATR-IR spectroscopy. In FIG. 2, these principles are illustrated in the context of the conventional set-up showing a single IRE for performing ATR-IR spectroscopy analysis.

As shown in FIGS. 1 and 2, “Attenuated Total Reflection” (ATR) employs an internal reflective element (IRE) 10 through which an IR beam 20 is passed. The sample is deposited directly onto the IRE 10. The specific refractive properties of the IRE depends on the material from which the IRE is made, which can be for example diamond, germanium, zinc selenide or silicon. As shown in FIG. 1, when the IR light beam 20 is passed through the IRE 10 at an angle 81 above the critical angle, the beam 20 is internally reflected through this medium on its upper surface 12 in contact with the sample 30. When the beam 20 meets the IRE and sample interface 12, this results in the production of an evanescent wave 14 which penetrates into the sample 30. The depth of this penetration is dependent upon the refractive indices of the IRE 10 and the sample 30, and is generally in the range of 0.5-2 μm. The beam 20, which then contains information about the sample 30, is then reflected by the IRE 10 towards a detector.

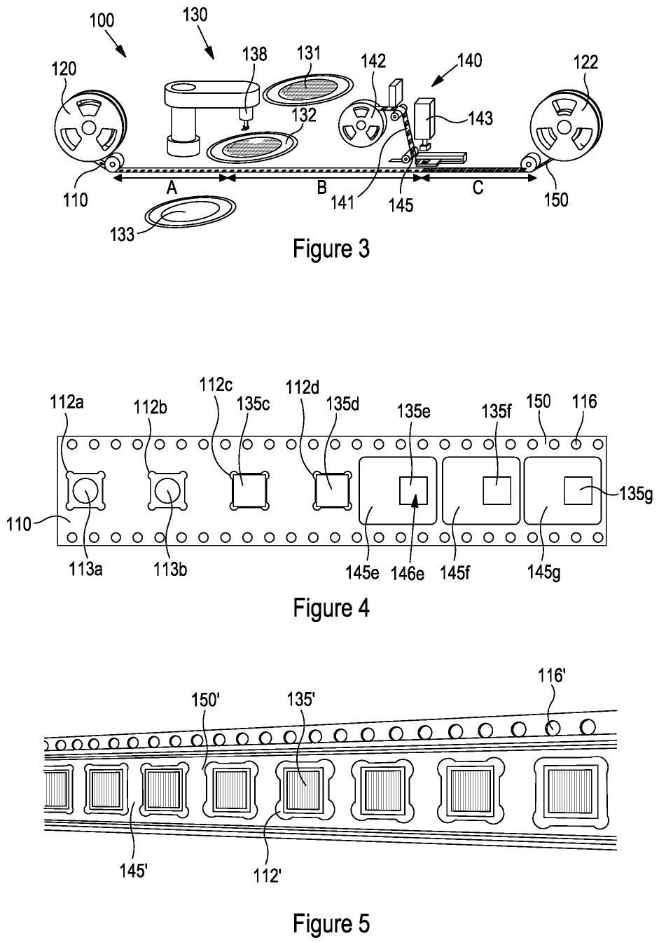

FIG. 3 shows a schematic view of a system 100 and associated method for making a sample support apparatus 150, according to an embodiment. The sample support apparatus 150 is shown in more detail in FIGS. 4 and 5.

An elongate flexible support 110 is provided on a first reel 120. The elongate flexible support 110 has a plurality of receiving portions 112 each configured to receive a respective internal reflection element (IRE) 135. The receiving portions 112 are provided on a sample side (which in use corresponds to an upper side) of the elongate flexible support 110. The elongate flexible support 110 has a beam side (which in use corresponds to a lower side) opposite the sample side.

In this embodiment, the elongate flexible support 110 has a width of about 12-16 mm. However, in other embodiments, the elongate flexible support 110 may have a width corresponding to the standard width of a microscope slide, in this embodiment about 25 mm. This may help allow the apparatus to be used with a conventional FTIR spectrometer.

Advantageously, the elongate flexible support 110 also has a height or depth corresponding to the standard height or depth of a microscope slide, in this embodiment about 1 mm.

As shown in FIG. 3, the elongate flexible support 110 is unwound from first reel 120 and held taut as it is fed through slide dispenser 130. Thus, as shown by section “A” of elongate flexible support 110 in FIG. 3, upstream of the slide dispenser 130, the elongate flexible support 110 is devoid of any IRE slides thereon.

In this embodiment, slide dispenser 130 includes an automated robotic arm 138 configured to place an IRE 135 in a respective receiving portion 112 of the elongate flexible support 110.

The IREs 135 are provided on a slide tray 131 which has a number of IREs thereon. In use, the tray 132 is located near the slide dispenser 130 to allow the arm 138 to automatically pick an IRE 135 from the tray 132 and apply it in a respective receiving portion 112 of the support 110. When all IREs on a tray have been used, such tray (shown as 133), is displaced and replaced by another tray 131 to continue application of IREs 135 on support 110.

The IREs 135 are placed such that a sample-receiving portion thereof faces upwards (i.e. away from recess 112 of support 110), and a beam-receiving portion thereof faces downwards (i.e. towards recess 112 of support 110).

Downstream from slide dispenser 130 is a cover dispenser 140 configured to apply a holding element 145 on an upper (sample) side of the support 110.

As shown by section “B” of elongate flexible support 110 in FIG. 3, the section B of support 110 downstream of slide dispenser 130 and upstream of cover dispenser 140 has an IRE 135 in each of the support recesses 112.

In this embodiment, the holding elements 145 consist of adhesive labels provided on a tape 141. As the support 110 is fed through cover dispenser 140, tape 141 is also fed through the cover dispenser 140 from tape reel 142, and a robot 143 automatically applies a label 145 onto a portion of a respective IRE 135.

As best shown in FIG. 4, in this embodiment, each label 145 partially covers a peripheral portion of a respective IRE 135. Each label 145 also covers a portion of a sample side of the flexible support 110 directly adjacent and around the IREs 135. Thus, at least a portion of the IREs 135 on a sample side thereof is sandwiched between the flexible support 110 and its respective label 145.

In this embodiment, each label 145 is configured to secure and/or hold a respective IRE 135 in place, e.g. within its respective recess 112 of the support 110.

As best shown in FIG. 4, each label 145 has an aperture 146 near a central region thereof which is configured to expose a portion of the sample side of a respective IRE 135.

However, it will be appreciated that, in other embodiments, each label 145 may be sized so as to cover a portion of more than one IRE slide, and that in such instance each label may have more than one aperture 146 so as to expose a portion of the sample side of all the IREs covered by the label.

The size of aperture 146 of labels 145 is slightly less than the size of the sample-receiving portion of the IREs 135. By such provision, a sample may be applied to the sample side of each IRE 135, whilst providing a further physical barrier between adjacent sample-receiving portions, thus further reducing the risk of cross-contamination between adjacent sample-receiving portions or IREs 135.

In this embodiment, the IREs 135 are approximately 6 mm×6 mm in size with a grooved area on their beam-receiving portions of about 5 mm×5 mm, and the apertures 146 have a size of approximately 3-4 mm×3-4 mm.

The assembled sample support apparatus 150 in represented by section “C” in FIG. 3, downstream of cover dispenser 140.

The sample support apparatus 150 is then wound on a second reel 122. By such provision, a continuous sample support apparatus 150 having multiple IREs thereon can be prepared effectively and stored conveniently.

The sample support apparatus 150 has holes 116 along the edges of the flexible support 110 to aid unwinding of the flexible support 110 (e.g. from first reel 120), winding of sample support apparatus 150 (e.g. on second reel 122), and/or handling of the sample support apparatus 150 and/or flexible support 110 during the process and/or subsequent use.

Referring to FIG. 4, the flexible support 110 is shown on its left hand side with two recesses 112a,112b each having an opening 113a,113b on a beam side of the support 110, corresponding to section “A” on the support 110 in FIG. 3. Each opening 113a,113b is configured to allow irradiation of a beam side of an associated IRE, but to prevent the IRE from falling through the openings 113a,113b. In this embodiment, the openings are circular and have a diameter of approximately 2 mm. However, it will be appreciated that in other embodiments the openings may be square, rectangular, elliptical, and any other suitable shape, and may have a dimension, e.g. diameter or width, or about 2-5 mm.

Referring to FIG. 4, the central section of flexible support 110 corresponds to section “B” in FIG. 3, and shows IREs 135c,135d placed within respective recesses 112c,112d.

Finally, the section of the sample support apparatus 150 on the right hand side of FIG. 4 corresponds to section “C” in FIG. 3, and shows a labels 145e,145f,145g applied on an outer portion of respective IREs 135e,135f,135g, and with their respective apertures 146e,146f,146g over a central portion of IREs 135e,135f,135g.

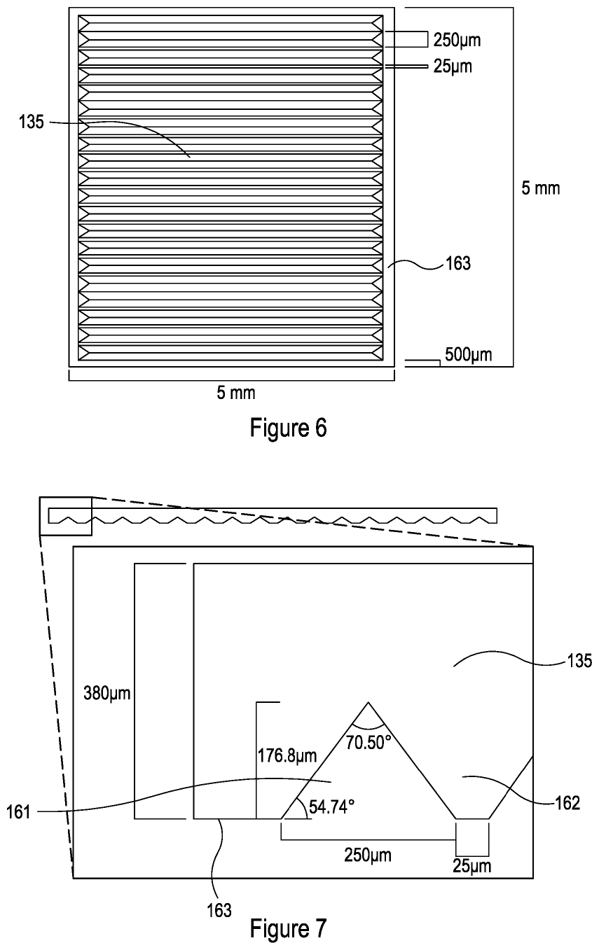

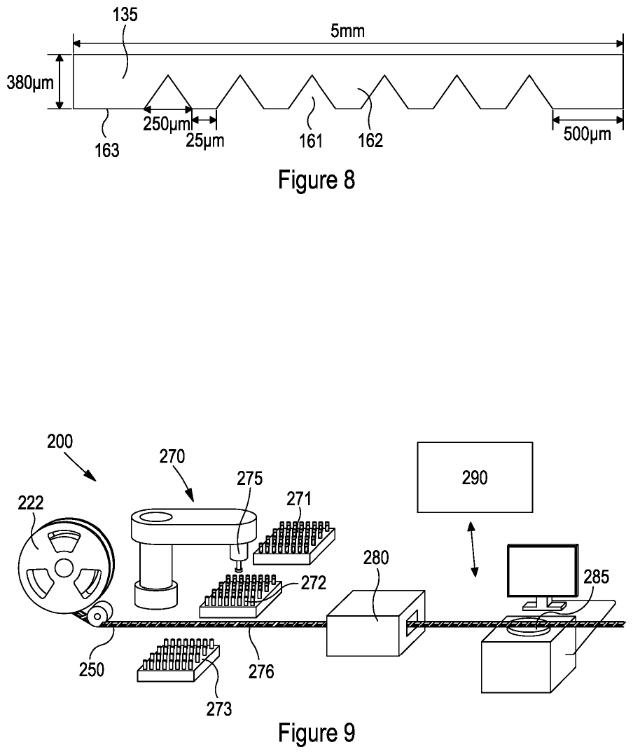

FIGS. 6, 7 and 8 show an embodiment of an IRE 135 used in the apparatus 150 of FIGS. 3-5. FIG. 6 is a view of the beam side of the IRE 135, whilst FIGS. 7 and 8 show cross-sectional views of the IRE 135.

In this embodiment, beam-receiving portion of IRE 135 is configured to permit a radiation beam to penetrate a surface of the IRE 135 on the beam side of the IRE 135.

Each beam-receiving portion defines a plurality of elongate grooves 161 and prisms 162. Conveniently, each beam-receiving portion defines has a plurality of aligned, parallel and adjacent grooves 161 and prisms 162.

In this embodiment, the prisms 162 are recessed relative to a lower surface 163 of the IRE 135 on the beam side thereof. The IRE 135 has a peripheral region defined by the lower surface 163, which assists in locating and supporting the IRE 135 when placed in its respective recess 112 of the elongate flexible support 110.

However, in another embodiment, the prisms 162 may protrude outwardly relative to the lower surface 163 of the IRE 135 on the beam side thereof. Other alternative embodiments may be envisaged in which an outer portion of the prisms 162 may protrude outwardly relative to the lower surface 163, and an inner portion of the prisms 162 may be recessed relative to the lower surface 163.

In this embodiment, the silicon IREs 135 had a thickness of 380 μm, and grooves 161 had a width of 250 μm, a depth of 176.8 μm, and a spacing of 25 μm.

FIG. 9 is a schematic view of a system, generally designated 200, for measuring a sample, according to an embodiment.

The system 200 has a reel 222 with a sample support apparatus 250 wound thereon. The sample support apparatus 250 is similar to the sample support apparatus 150 of FIGS. 3-5, like parts denoted by like numerals, incremented by ‘100’.

The system 200 is configured to permit in-line or continuous measurement of samples 276 by FTIR spectroscopy.

The system 200 includes a sample dispenser 270 located downstream from reel 222 and configured to apply a sample 276 on the sample-receiving portion of an IRE 235 of the sample support apparatus 250.

In use, the system 200 permits supply of sample support apparatus 250 by unwinding it from reel 222 in a linear direction.

As each IRE 235 passes through or near sample dispenser 270, the robotic arm 275 thereof dispenses a predetermined amount of sample 276 on a sample-receiving portion of the IRE 235. Typically, the sample support apparatus 250 is kept stationary whilst sample 276 is applied on respective IRE 235.

The samples 276 are provided on a sample tray 271 which has a number of samples 276 thereon. In use, tray 272 is located near the sample dispenser 270 to allow the arm 275 to automatically obtain a predetermined amount of sample 276 from the tray 272 and apply it to a respective IRE 235 of the sample support apparatus 250. When all samples 276 on a tray have been used, such tray (shown as 273), is displaced and replaced by another tray 271 to continue dispensing of sample 275 on IREs 235 of apparatus 250.

The system 200 further comprises a dryer 280 configured to dry wet samples 276 provided on the sample support apparatus 250. In this embodiment, the dryer 280 is an oven including an air flow supply. It will be appreciated that, in the event that dry samples are applied on the sample support apparatus 250, a dryer may not be required.

The system includes one or more spectrometers 285, which is provided downstream of the sample dispenser 270 and of the dryer 280. In this embodiment the spectrometer is an ATR-FTIR spectrometer.

In this embodiment, there is provided a single spectrometer 285 for ease of representation. However, it will be appreciated that multiple spectrometers may be coupled to the system in order to further increase the capacity of the system and increase throughput. For example, if there are four spectrometers, the first spectrometer may be configured to measure a sample at position n, the second spectrometer may be configured to measure a sample at position n+1, the third spectrometer may be configured to measure a sample at position n+2, and the fourth spectrometer may be configured to measure a sample at position n+3. After each multiple measurement, the sample support apparatus 250 would then be moved such that the sample at position n+4 would be measured by the first spectrometer, etc. By such provision, the time required to perform measurement or analysis of the samples on the sample support apparatus 250 may be reduced.

The system 200 is automated in order to maximise reliability, repeatability and throughput capacity.

The system 200 is associated with a controller 290 configured to control movement, e.g. translation, of the sample support apparatus 250.

The controller may control movement, e.g. translation and/or unwinding of the sample support apparatus 250, by a predetermined distance.

Typically, the controller 290 maintains the sample support apparatus stationary whist a sample 276 is applied on the sample support apparatus 250. This may help the accuracy of the sample application. Typically also, the controller 290 maintains the sample support apparatus 250 stationary whist one or more samples 276 is/are being measured by the spectrometer(s) 285.

The provision of a sample support apparatus 250 having numerous successive IREs 235 allows for automated in-line, continuous measurements of numerous samples 276 without having to remove and replace a sample slide between successive measurements as per current approaches. This may avoid the need to remove, clean and dry an IRE between successive measurements as is current practice, thus permitting high throughput ATR-FTIR analysis.

It will be appreciated that the described embodiments are not meant to limit the scope of the present invention, and the present invention may be implemented using variations of the described examples.

1. A sample support apparatus for use in a spectrometer, wherein the sample support apparatus comprises:
an elongate support comprising a plurality of receiving portions each configured to receive a respective internal reflection element (IRE) or IRE slide, the elongate support having a sample side and a beam side opposite the sample side; and
a plurality of IREs or IRE slides, each IRE or IRE slide provided at a respective receiving portion of the elongate support, wherein each IRE or IRE slide has at least one sample-receiving portion provided on a sample side thereof, and at least one beam-receiving portion provided on a beam side thereof,
wherein the sample support apparatus has a stowed configuration, and a deployed configuration configured to allow application of a sample on one or more of the plurality of IREs or IRE slides.

2. A sample support apparatus according to claim 1, wherein the elongate support of the sample support apparatus is flexible.

3. A sample support apparatus according to claim 1, wherein the sample support apparatus is capable of being wound or spooled on or around a storing device.

4. A sample support apparatus according to claim 1, wherein the elongate support comprises or is provided in the form of a ribbon or tape.

5. A sample support apparatus according to claim 1, wherein the plurality of receiving portions are aligned longitudinally along the elongate support.

6. A sample support apparatus according to claim 1, wherein the plurality of receiving portions are spaced apart at regular intervals on the elongate support.

7. A sample support apparatus according to claim 1, wherein each receiving portion is configured to receive a respective internal reflection element (IRE), and wherein each IRE has one sample-receiving portion provided on a sample side of the slide, and one beam-receiving portion provided on a beam side of the slide.

8. A sample support apparatus according to claim 1, wherein the receiving portions each comprises one or more openings on a beam side of the elongate support, wherein each opening has a size less than the size of a respective IRE.

9. (canceled)

10. A sample support apparatus according to claim 1, wherein each receiving portion comprises a recess on a sample side of the elongate support, each receiving portion being configured to receive a respective IRE.

11. A sample support apparatus according to claim 1, wherein the elongate support comprises approximately between 10 and 5000 receiving portions and/or wherein the sample support apparatus comprises approximately between 10 and 5000 IREs.

12. A sample support apparatus according to claim 1, wherein the sample support apparatus further comprises at least one holding element provided on a sample side of the elongate support, the at least one holding element being configured to cover at least a portion of at least one IRE, wherein the/each holding element comprises at least one aperture configured to expose a portion of the sample side of a respective IRE and wherein the at least one aperture has a size equal to or less than the size of a sample-receiving portion of a respective IRE.

13. (canceled)

14. (canceled)

15. A sample support apparatus according to any claim 11, wherein the at least one holding element is provided in the form of a film or a tape.

16. A kit of parts for providing a sample support apparatus, the kit of parts comprising:
an elongate support comprising a plurality of receiving portions each configured to receive a respective internal reflection element (IRE) or IRE slide, the elongate support having a sample side and a beam side opposite the sample side, wherein the elongate support has a stowed configuration, and a deployed configuration configured to allow application of one or more IREs or IRE slides thereon; and
a plurality of IREs or IRE slides, each IRE or IRE slide configured to be provided at a respective receiving portion of the elongate support, wherein each IRE or IRE slide has at least one sample-receiving portion provided on a sample side thereof, and at least one beam-receiving portion provided on a beam side thereof.

17. A kit of parts according to claim 16, further comprising a holding element arranged to be provided on a sample side of the elongate support and configured to cover at least a portion of at least one IRE.

18. A method of making a sample support apparatus, the method comprising:
providing an elongate support comprising a plurality of receiving portions each configured to receive a respective IRE or IRE slide, the elongate support having a sample side and a beam side opposite the sample side, wherein the sample support apparatus has a stowed configuration, and a deployed configuration configured to allow application of a sample on one or more of the plurality of IREs or IRE slides; and
disposing at least one IRE or IRE slide in a respective receiving portion of the elongate support, wherein the at least one IRE or IRE slide has at least one sample-receiving portion provided on a sample side thereof, and at least one beam-receiving portion provided on a beam side thereof.

19. A method according to claim 18, comprising disposing a plurality of IREs or IRE slides on the elongate support, each IRE or IRE slide being provided in a respective receiving portion of the elongate support.

20. A method according to claim 18, comprising moving the elongate support in a linear direction.

21. (canceled)

22. A method according to claim 18, further comprising applying a holding element on a sample side of the elongate support so as to cover at least a portion of at least one IRE.

23. A method according to claim 18, comprising stowing the sample support apparatus.

24. A system for measuring a sample, the system comprising:
a dispenser configured to supply a sample support apparatus according to claim 1;
a sample dispenser configured to apply a sample on a sample-receiving portion of the sample support apparatus; and
a spectrometer.

25. A method for measuring a sample, the method comprising:
supplying a sample support apparatus according to claim 1;
applying a sample on a sample-receiving portion of the sample support apparatus; and
moving the sample support apparatus to a spectrometer so as to measure the sample.
